(19) United States
(12) Patent Application Publication
(10) Pub. No.: US 2022/0044079 A1
(43) Pub. Date: Feb. 10, 2022

(54) SPACE-BASED CROSS-SENSOR OBJECT POSITIONING AND IDENTIFICATION METHOD AND SYSTEM

(71) Applicant: QNAP SYSTEMS, INC., NEW TAIPEI CITY (TW)

(72) Inventors: Kung-Han CHEN, NEW TAIPEI CITY (TW); Peng-Yan SIE, NEW TAIPEI CITY (TW); Jian-Kai WANG, NEW TAIPEI CITY (TW); Yun-Tao CHEN, NEW TAIPEI CITY (TW)

(21) Appl. No.: 17/140,681

(22) Filed: Jan. 4, 2021

(30) Foreign Application Priority Data
Aug. 10, 2020 (TW) 109127116

(51) Int. Cl. G06K 9/62; G06T 7/73; G06K 9/78; G06T 7/292; H04N 5/247; H04N 7/18

(52) U.S. Cl. CPC G06K 9/6289; G06T 7/74; G06K 9/78; G06T 7/292; G06T 2207/30241; H04N 7/181; G06K 9/6261; G06T 2207/30232; H04N 5/247

(57) ABSTRACT

A space-based cross-sensor object positioning and identification method for detecting at least one object in a space, including: periodically performing an object bounding box defining process on raw data of an image sensed by each of a plurality of image sensing devices to generate at least one bounding box for at least one aforementioned object, and performing a first inference process and a second inference process on each aforementioned bounding box to generate a grid code and an attribute vector respectively; and performing a third inference process on plural combined data sets of the grid code and the attribute vector deduced from the images sensed by the image sensing devices to map at least one aforementioned combined data set attributed to a same identity to a local area on a reference plane of the space.

### BACKGROUND OF THE INVENTION

### Field of the Invention

The present invention relates to a method for detecting the position of an object in a space, and more particularly to a method for locating an object in a space by using a cross-sensor collaborative detection scheme.

### Description of the Related Art

In general buildings or stores, cameras are installed at the corners of the internal space, and multiple screens are set up in a monitoring room for a security guard to monitor the internal space of the building or the store, so that the security guard can respond to emergencies in the internal space in time.

However, general cameras installed in buildings or stores only display the captured images or the analysis results of the captured images on corresponding screens respectively, and do not have a collaborative processing function. Therefore, for the security guard responsible for monitoring the screens, it is not only difficult to stay focused for a long time when monitoring multiple screens at the same time, but also difficult to identify abnormal events or suspicious persons.

To solve the problems mentioned above, a novel object positioning scheme in a space is urgently needed.

### SUMMARY OF THE INVENTION

One objective of the present invention is to provide a space-based cross-sensor object positioning and identification method, which can perform an object bounding box defining process on images sensed by plural image sensing devices to generate at least one bounding box of an object, and use each of the at least one bounding box to generate a grid code and an attribute vector to determine an identity of the object and the object's position in the space.

Another objective of the present invention is to provide a space-based cross-sensor object positioning and identification method, which can periodically obtain a set of bounding boxes of an object from plural images sensed by plural image sensing devices, where each set of the bounding boxes includes at least one bounding box, the at least one bounding box corresponds to a same grid code, and at least one attribute vector corresponding to the at least one bounding box will be determined to belong to a same identity, and which can thereby use sequentially obtained plural sets of the bounding boxes to locate a trajectory of the object in the space.

Still another objective of the present invention is to provide a space-based cross-sensor object positioning and identification system, which can efficiently execute the object positioning and identification method of the present invention by adopting an edge computing architecture.

To achieve the above objectives, a space-based cross-sensor object positioning and identification method is proposed for detecting at least one object in a space by using cooperation of a plurality of image sensing devices disposed in the space, the method being implemented by an edge computing architecture including a main information processing device and a plurality of information processing units respectively disposed in the image sensing devices, and the method including:

periodically receiving raw data of a plurality of images sensed by the image sensing devices;

performing an object bounding box defining process on raw data of the image sensed by each of the image sensing devices to generate at least one bounding box of at least one of the at least one object, and performing a first inference process and a second inference process on each aforementioned bounding box to generate a grid code and an attribute vector respectively, and storing the grid code and the attribute vector in a memory in a related manner; and

performing a third inference process on plural combined data sets of the grid code and the attribute vector deduced from the images of the image sensing devices to map at least one aforementioned combined data set determined to belong to a same identity to a local area on a reference plane of the space;

where the first inference process includes: dividing the reference plane into a plurality of grids and setting a plurality of different grid codes for the grids, performing a central-point calculation on an aforementioned bounding box to find a projection point on the reference plane, and using a look-up table to find a corresponding aforementioned grid code for the projection point; the second inference process includes: using a first AI module to perform an attribute evaluation calculation on an aforementioned bounding box to determine an aforementioned attribute vector; and the third inference process includes: using a second AI module to perform an identity evaluation calculation on the attribute vectors to determine at least one aforementioned identity, and mapping at least one aforementioned combined data set of the grid code and the attribute vector that corresponds to an aforementioned identity to an aforementioned local area on the reference plane.

In one embodiment, the information processing units have at least one hardware acceleration unit.

In one embodiment, each of the grids is of a polygonal shape.

In one embodiment, the edge computing architecture further uses sequentially obtained aforementioned grid codes corresponding to an aforementioned identity to find a trajectory of an aforementioned object on the reference plane.

In possible embodiments, the grid codes can be Arabic numerals or English letters or symbols.

To achieve the above objectives, the present invention further provides a space-based cross-sensor object positioning and identification system, which has an edge computing architecture including a main information processing device and a plurality of information processing units respectively disposed in a plurality of image sensing devices installed in a space, and the edge computing architecture is used to execute a space-based cross-sensor object positioning and identification method for detecting at least one object in a space by using cooperation of the image sensing devices, and the method includes: periodically receiving raw data of a plurality of images sensed by the image sensing devices;

performing an object bounding box defining process on raw data of the image sensed by each of the image sensing devices to generate at least one bounding box of at least one of the at least one object, and performing a first inference process and a second inference process on each aforementioned bounding box to generate a grid code and an attribute vector respectively, and storing the grid code and the attribute vector in a memory in a related manner; and

performing a third inference process on plural combined data sets of the grid code and the attribute vector deduced from the images of the image sensing devices to map at least one aforementioned combined data set determined to belong to a same identity to a local area on a reference plane of the space;

where the first inference process includes: dividing the reference plane into a plurality of grids and setting a plurality of different grid codes for the grids, performing a central-point calculation on an aforementioned bounding box to find a projection point on the reference plane, and using a look-up table to find a corresponding aforementioned grid code for the projection point; the second inference process includes: using a first AI module to perform an attribute evaluation calculation on an aforementioned bounding box to determine an aforementioned attribute vector; and the third inference process includes: using a second AI module to perform an identity evaluation calculation on the attribute vectors to determine at least one aforementioned identity, and mapping at least one aforementioned combined data set of the grid code and the attribute vector that corresponds to an aforementioned identity to an aforementioned local area on the reference plane.

In one embodiment, the information processing units have at least one hardware acceleration unit.

In one embodiment, each of the grids is of a polygonal shape.

In one embodiment, the edge computing architecture further uses sequentially obtained aforementioned grid codes corresponding to an aforementioned identity to find a trajectory of an aforementioned object on the reference plane.

In possible embodiments, the grid codes can be Arabic numerals or English letters or symbols.

In possible embodiments, the main information processing device can be a cloud server, a local server or a computer device.

In possible embodiments, the image sensing devices can communicate with the main information processing device in a wired or wireless manner.

### BRIEF DESCRIPTION OF THE DRAWINGS

FIG. 1 illustrates a flowchart of an embodiment of a space-based cross-sensor object positioning and identification method of the present invention.

FIG. 2 illustrates a system applying the method of FIG. 1, where the system has an edge computing architecture, and the edge computing architecture includes a main information processing device and a plurality of information processing units respectively disposed in a plurality of image sensing devices distributed in a space to enable the image sensing devices to cooperatively detect at least one object.

FIG. 3 illustrates that a reference plane of the space shown in FIG. 2 is divided into a plurality of polygonal grids.

FIG. 4a-4e illustrate that the system of FIG. 2 is used to detect a man walking in the space shown in FIG. 2.

### DETAILED DESCRIPTION OF THE PREFERRED EMBODIMENTS

To make it easier for our examiner to understand the objective of the invention, its structure, innovative features, and performance, we use preferred embodiments together with the accompanying drawings for the detailed description of the invention.

The principle of the present invention lies in:

(1) Divide a reference plane representing a space into multiple polygonal grids, and assign a code to each grid to represent a position thereof, where the codes are assigned to the grids in a predetermined order, so that the present invention can quickly detect the position of an object in the space without calculating the coordinates (x, y) of each position on the reference plane;

(2) Employ a plurality of image sensing devices in the space, and use a mapping operation to map images sensed by the image sensing devices to the reference plane;

(3) Use an edge computing architecture to perform an object bounding box definition process on the images sensed by the image sensing devices to generate at least one bounding box for an object, and generate a grid code and an attribute vector for each aforementioned bounding box to determine an identity of the object and a position of the object in the space; and

(4) Use the edge computing architecture to periodically obtain a bounding box set for an object from the images sensed by the image sensing devices, where each bounding box set has at least one bounding box, the at least one bounding box all correspond to a same grid code, and the at least one attribute vector corresponding to the at least one bounding box is determined to belong to a same identity, so that the bounding box sets obtained in a sequence can be used to find a trajectory of the object in the space.

For example, given a scenario that 4 cameras (C1, C2, C3, C4) are set in 4 corners of an indoor space, a man walks in the indoor space, and five image data sets captured by the edge computing architecture of the present invention during five image capturing periods are {IMG1(1), IMG2(1), IMG3(1), IMG4(1)}, {IMG1(2), IMG2(2), IMG3(2), IMG4(2)}, {(IMG1(3), IMG2(3), IMG3(3), IMG4(3)}, {IMG1(4), IMG2(4), IMG3(4), IMG4(4)} and {IMG1(5), IMG2(5), IMG3(5), IMG4(5)}, then the edge computing architecture of the present invention will use these image data sets to generate 5 bounding box sets of {bounding box C1(1)}, {bounding box C1(2), bounding box C2(2)}, {bounding box C2(3), bounding box C3(3)}, {bounding box C3(4), bounding box C4(4)} and {bounding box C4(5)} respectively. Next, the edge computing architecture of the present invention will perform a first inference process on these bounding box sets to obtain the following results:

(1) In the first bounding box set, the central-point of the bounding box C1(1) is mapped to the grid assigned with a first code, and the shape of the bounding box C1(1) results in a first attribute vector;

(2) In the second bounding box set, both the central-point of the bounding box C1(2) and the central-point of the bounding box C2(2) are mapped to the grid assigned with a second code, and the shapes of the bounding box C1(2) and the bounding box C2(2) result in a second attribute vector and a third attribute vector respectively;

(3) In the third bounding box set, both the central-point of the bounding box C2(3) and the central-point of the bounding box C3(3) are mapped to the grid assigned with a third code, and the shapes of the bounding box C2(3) and the bounding box C3(3) result in a fourth attribute vector and a fifth attribute vector respectively;

(4) In the fourth bounding box set, both the central-point of the bounding box C3(4) and the central-point of the bounding box C4(4) are mapped to the grid assigned with a fourth code, and the shapes of the bounding box C3(4) and the bounding box C4(4) result in a sixth attribute vector and a seventh attribute vector respectively; and

(5) In the fifth bounding box set, the central-point of the bounding box C4(5) is mapped to the grid assigned with a fifth code, and the shape of the bounding box C4(5) results in an eighth attribute vector.

Next, the eight attribute vectors from the first attribute vector through the eighth attribute vector will be attributed to a same identity after being processed by a second inference process executed by the edge computing architecture of the present invention, and accordingly the present invention can find out the positions or trajectory of the man in the indoor space.

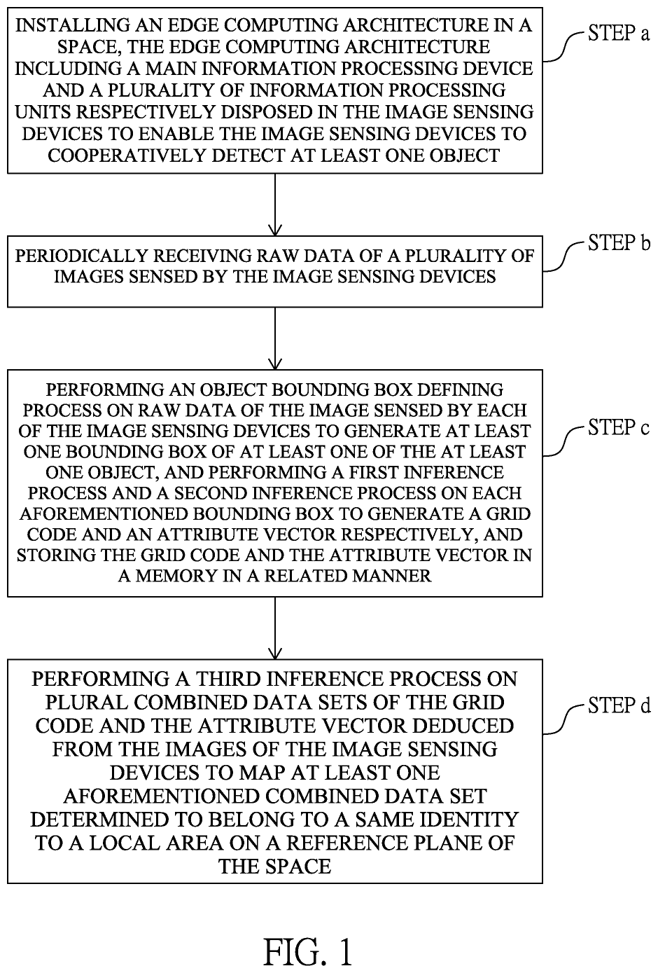

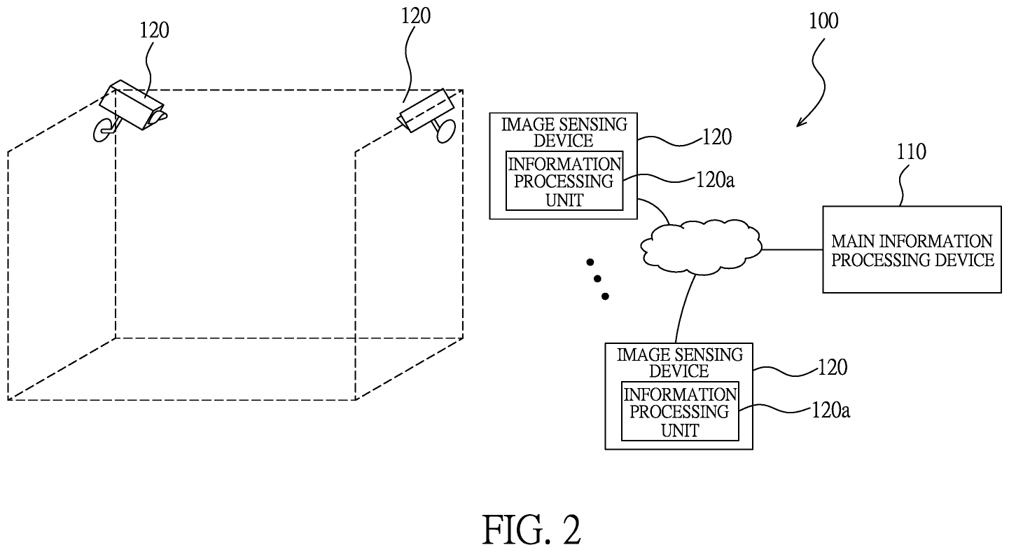

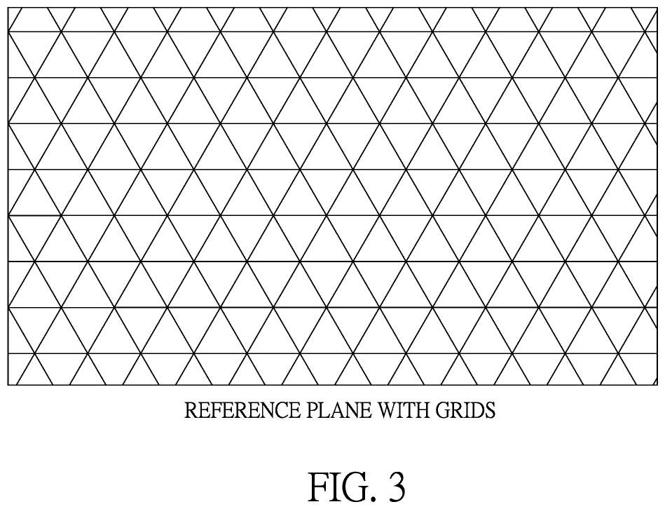

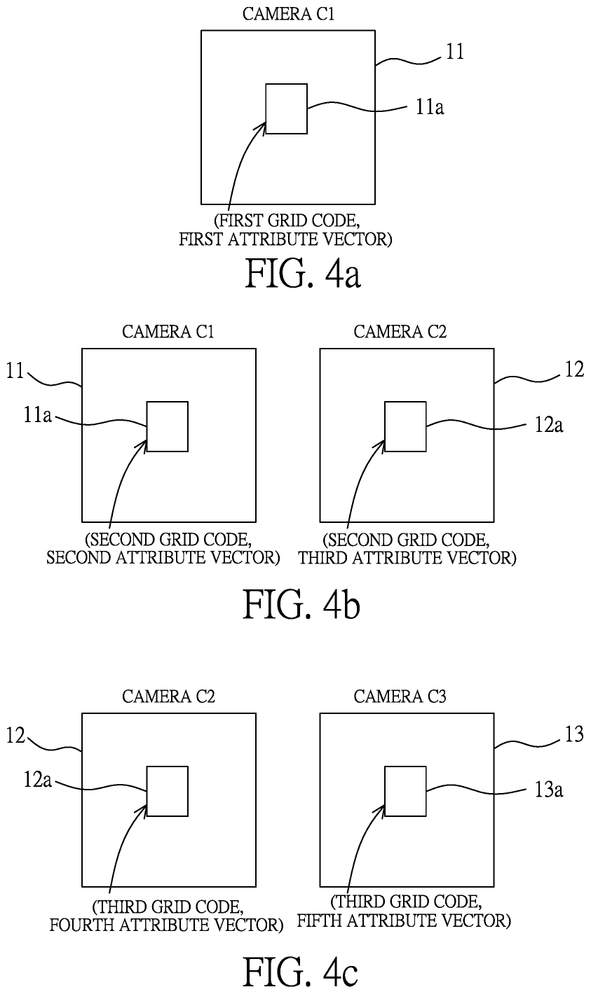

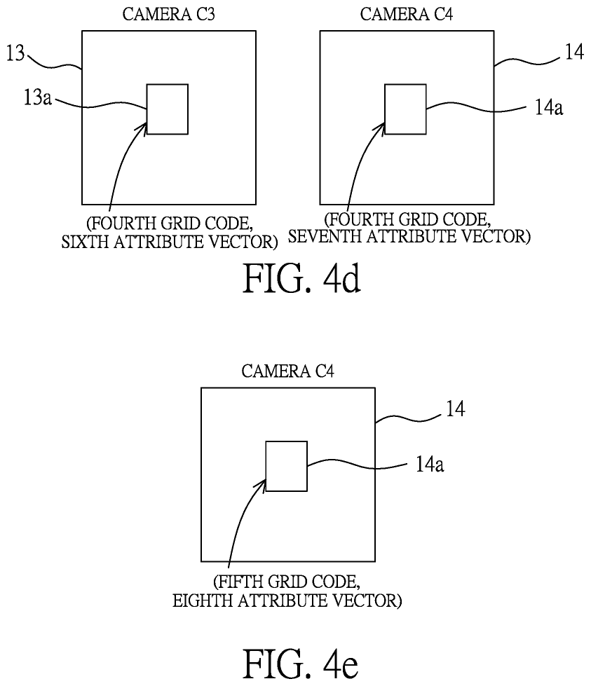

Please refer to FIGS. 1 to 4a-4e, in which, FIG. 1 illustrates a flowchart of an embodiment of a space-based cross-sensor object positioning and identification method of the present invention; FIG. 2 illustrates a system applying the method of FIG. 1, where the system has an edge computing architecture, and the edge computing architecture includes a main information processing device and a plurality of information processing units respectively disposed in a plurality of image sensing devices distributed in a space to enable the image sensing devices to cooperatively detect at least one object; FIG. 3 illustrates that a reference plane of the space shown in FIG. 2 is divided into a plurality of polygonal grids; and FIG. 4a-4e illustrate that the system of FIG. 2 is used to detect a man walking in the space shown in FIG. 2.

As shown in FIG. 1, the method includes the following steps: installing an edge computing architecture in a space, the edge computing architecture including a main information processing device and a plurality of information processing units respectively disposed in the image sensing devices to enable the image sensing devices to cooperatively detect at least one object (step a); periodically receiving raw data of a plurality of images sensed by the image sensing devices (step b); performing an object bounding box defining process on raw data of the image sensed by each of the image sensing devices to generate at least one bounding box of at least one of the at least one object, and performing a first inference process and a second inference process on each aforementioned bounding box to generate a grid code and an attribute vector respectively, and storing the grid code and the attribute vector in a memory in a related manner (step c); and performing a third inference process on plural combined data sets of the grid code and the attribute vector deduced from the images of the image sensing devices to map at least one aforementioned combined data set determined to belong to a same identity to a local area on a reference plane of the space (step d).

In step a, the information processing units may have at least one hardware acceleration unit.

In step c, the present invention divides a plurality of grids on a reference plane of the space and sets a plurality of different aforementioned grid codes on the grids, and the grids are each of a polygonal shape, for example but not limited to a triangle, a quadrilateral, or a hexagon.

In addition, in step c, the first inference process includes: dividing the reference plane into a plurality of grids and setting a plurality of different aforementioned grid codes for the grids, performing a central-point calculation on an aforementioned bounding box to find a projection point on the reference plane, and using a look-up table to find a corresponding aforementioned grid code for the projection point; the second inference process includes: using a first AI module to perform an attribute evaluation calculation on an aforementioned bounding box to determine an aforementioned attribute vector. In addition, the grid codes can be Arabic numerals or English letters or symbols.

In addition, in step d, the third inference process includes: using a second AI module to perform an identity evaluation calculation on the attribute vectors to determine at least one aforementioned identity, and mapping at least one aforementioned combined data set of the grid code and the attribute vector that corresponds to an aforementioned identity to an aforementioned local area on the reference plane.

Based on the above disclosure, the present invention can sequentially obtain multiple bounding box sets of an object, and find out the positions or trajectory of the object in the space accordingly.

As shown in FIG. 2, the system of the present invention has an edge computing architecture 100, which includes a main information processing device 110 and a plurality of image sensing devices 120 arranged in a space, where the main information processing device 110 can be a cloud server, a local server or a computer device; each image sensing device 120 has an information processing unit 120a, and each information processing unit 120a communicates with the main information processing device 110 via a wired or wireless network, so as to perform the aforementioned method to enable the image sensing devices 120 to cooperatively detect at least one object.

That is, when in operation, the edge computing architecture 100 will perform the following steps:

(1) Periodically receives raw data of a plurality of images sensed by the image sensing devices 120.

(2) Performs an object bounding box defining process on raw data of the image sensed by each of the image sensing devices 120 to generate at least one bounding box of at least one of the at least one object, and performs a first inference process and a second inference process on each aforementioned bounding box to generate a grid code and an attribute vector respectively, and stores the grid code and the attribute vector in a memory (not shown in the figure) in a related manner.

(3) Performs a third inference process on plural combined data sets of the grid code and the attribute vector deduced from the images of the image sensing devices 120 to map at least one aforementioned combined data set determined to belong to a same identity to a local area on a reference plane of the space.

In addition, the information processing units 120a may have at least one hardware acceleration unit.

In addition, as shown in FIG. 3, the present invention divides a plurality of grids on a reference plane of the space and sets a plurality of different aforementioned grid codes on the grids, and the grids are each of a polygonal shape, for example but not limited to a triangle, a quadrilateral, or a hexagon.

In addition, the first inference process includes: dividing the reference plane into a plurality of grids and setting a plurality of different aforementioned grid codes for the grids, performing a central-point calculation on an aforementioned bounding box to find a projection point on the reference plane, and using a look-up table to find a corresponding aforementioned grid code for the projection point; the second inference process includes: using a first AI module to perform an attribute evaluation calculation on an aforementioned bounding box to determine an aforementioned attribute vector. In addition, the grid codes can be Arabic numerals or English letters or symbols.

In addition, the third inference process includes: using a second AI module to perform an identity evaluation calculation on the attribute vectors to determine at least one aforementioned identity, and mapping at least one aforementioned combined data set of the grid code and the attribute vector that corresponds to an aforementioned identity to an aforementioned local area on the reference plane.

In addition, please refer to FIGS. 4a-4e, which illustrate that the system of FIG. 2 is used to detect a man walking in the space shown in FIG. 2. with 4 cameras (C1, C2, C3, C4) installed in 4 corners. As shown in FIGS. 4a-4e, when the man is walking in the space, the first bounding box set obtained by the edge computing architecture of the present invention during the first image capturing period is {the bounding box 11a of image 11 sensed by camera C1}; the second bounding box set obtained during the second image capturing period is {bounding box 11a of image 11 sensed by camera C1, bounding box 12a of image 12 sensed by camera C2}; the third bounding box set obtained during the third image capturing period is {bounding box 12a of image 12 sensed by camera C2, bounding box 13a of image 13 sensed by camera C3}; the fourth bounding box set obtained during the fourth image capturing period is {bounding box 13a of image 13 sensed by camera C3, bounding box 14a of image 14 sensed by camera C4}; the fifth bounding box obtained during the fifth image capturing period is {bounding box 14a of image 14 sensed by camera C4}. With the bounding box sets obtained in the image capturing periods, the present invention can use the method mentioned above to process the bounding box sets to find the positions or trajectory of the man in the space.

That is, the present invention can sequentially obtain multiple bounding box sets of an object and find out the positions or trajectory of an object in the space accordingly.

Thanks to the proposals disclosed above, the present invention possesses the following advantages:

(1) The space-based cross-sensor object positioning and identification method of the present invention can perform an object bounding box defining process on images sensed by plural image sensing devices to generate at least one bounding box of an object, and use each of the at least one bounding box to generate a grid code and an attribute vector to determine an identity of the object and the object's position in a space.

(2) The space-based cross-sensor object positioning and identification method of the present invention can periodically obtain a set of bounding boxes of an object from plural images sensed by plural image sensing devices, where each set of the bounding boxes includes at least one bounding box, the at least one bounding box corresponds to a same grid code, and at least one attribute vector corresponding to the at least one bounding box will be determined to belong to a same identity, and which can thereby use sequentially obtained plural sets of the bounding boxes to locate a trajectory of the object in the space.

(3) The space-based cross-sensor object positioning and identification system of the present invention can efficiently execute the object positioning and identification method of the present invention by adopting an edge computing architecture.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A space-based cross-sensor object positioning and identification method for detecting at least one object in a space by using cooperation of a plurality of image sensing devices disposed in the space, the method being implemented by an edge computing architecture including a main information processing device and a plurality of information processing units respectively disposed in the image sensing devices, and the method including:
periodically receiving raw data of a plurality of images sensed by the image sensing devices;
performing an object bounding box defining process on raw data of the image sensed by each of the image sensing devices to generate at least one bounding box of at least one of the at least one object, and performing a first inference process and a second inference process on each said bounding box to generate a grid code and an attribute vector respectively, and storing the grid code and the attribute vector in a memory in a related manner; and
performing a third inference process on plural combined data sets of the grid code and the attribute vector deduced from the images of the image sensing devices to map at least one said combined data set determined to belong to a same identity to a local area on a reference plane of the space;
wherein the first inference process includes: dividing the reference plane into a plurality of grids and setting a plurality of different grid codes for the grids, performing a central-point calculation on one said bounding box to find a projection point on the reference plane, and using a look-up table to find a corresponding said grid code for the projection point; the second inference process includes: using a first AI module to perform an attribute evaluation calculation on one said bounding box to determine one said attribute vector; and the third inference process includes: using a second AI module to perform an identity evaluation calculation on the attribute vectors to determine at least one said identity, and mapping at least one said combined data set of the grid code and the attribute vector that corresponds to one said identity to one said local area on the reference plane.

2. The space-based cross-sensor object positioning and identification method as disclosed in claim 1, wherein the information processing units have at least one hardware acceleration unit.

3. The space-based cross-sensor object positioning and identification method as disclosed in claim 1, wherein each of the grids is of a polygonal shape.

4. The space-based cross-sensor object positioning and identification method as disclosed in claim 1, wherein the edge computing architecture further uses sequentially obtained said grid codes corresponding to one said identity to find a trajectory of one said object on the reference plane.

5. The space-based cross-sensor object positioning and identification method as disclosed in claim 1, wherein the grid codes are Arabic numerals or English letters or symbols.

6. A space-based cross-sensor object positioning and identification system, which has an edge computing architecture including a main information processing device and a plurality of information processing units respectively disposed in a plurality of image sensing devices installed in a space, and the edge computing architecture is used to execute a space-based cross-sensor object positioning and identification method for detecting at least one object in a space by using cooperation of the image sensing devices, and the method includes:
periodically receiving raw data of a plurality of images sensed by the image sensing devices;
performing an object bounding box defining process on raw data of the image sensed by each of the image sensing devices to generate at least one bounding box of at least one of the at least one object, and performing a first inference process and a second inference process on each said bounding box to generate a grid code and an attribute vector respectively, and storing the grid code and the attribute vector in a memory in a related manner; and
performing a third inference process on plural combined data sets of the grid code and the attribute vector deduced from the images of the image sensing devices to map at least one said combined data set determined to belong to a same identity to a local area on a reference plane of the space;
wherein the first inference process includes: dividing the reference plane into a plurality of grids and setting a plurality of different grid codes for the grids, performing a central-point calculation on one said bounding box to find a projection point on the reference plane, and using a look-up table to find a corresponding said grid code for the projection point; the second inference process includes: using a first AI module to perform an attribute evaluation calculation on one said bounding box to determine one said attribute vector; and the third inference process includes: using a second AI module to perform an identity evaluation calculation on the attribute vectors to determine at least one said identity, and mapping at least one said combined data set of the grid code and the attribute vector that corresponds to one said identity to one said local area on the reference plane.

7. The space-based cross-sensor object positioning and identification system as disclosed in claim 6, wherein the information processing units have at least one hardware acceleration unit.

8. The space-based cross-sensor object positioning and identification system as disclosed in claim 6, wherein each of the grids is of a polygonal shape.

9. The space-based cross-sensor object positioning and identification system as disclosed in claim 6, wherein the edge computing architecture further uses sequentially obtained said grid codes corresponding to one said identity to find a trajectory of one said object on the reference plane.

10. The space-based cross-sensor object positioning and identification system as disclosed in claim 6, wherein the grid codes are Arabic numerals or English letters or symbols.

11. The space-based cross-sensor object positioning and identification system as disclosed in claim 6, wherein the main information processing device is selected from a group consisting of a cloud server, a local server and a computer device.

12. The space-based cross-sensor object positioning and identification system as disclosed in claim 6, wherein the image sensing devices communicate with the main information processing device in a wired or wireless manner.
